(19) United States
(12) Patent Application Publication
(10) Pub. No.: US 2010/0024611 A1
(43) Pub. Date: Feb. 4, 2010

(54) POWER DRIVER AND METHOD OF USING THE SAME

(76) Inventors: Michael M. Starick, Chardon, OH (US); Phillip L. Klingler, Bryan, OH (US)

Correspondence Address: FAY SHARPE LLP, 1228 Euclid Avenue, 5th Floor, The Halle Building, Cleveland, OH, 44115, US

(21) Appl. No.: 12/511,363

(22) Filed: Jul. 29, 2009

Related U.S. Application Data
(60) Provisional application No. 61/137,292, filed on Jul. 29, 2008.

(51) Int. Cl. B25B 23/145; B25B 21/00

(52) U.S. Cl. 81/470; 81/474; 173/178

(57) ABSTRACT

A pneumatic driver for driving a fastener including an air inlet connectable to an air supply and a pneumatically driven motor driveable by air supply about a tool axis. The driver further including a bit holder, a torque control, and a push rod in mechanical communication with the torque control such that the pin is axially positionable between an off position, a drive position and a torque blocked position. The rod moving to the drive position in response to axial pressure being applied to the bit holder and driver further including an inlet air chamber and a signal pressure chamber fluidly connecting the air inlet and the motor. The driver further including a port between the inlet and signal chambers and a second port between the pressure chamber and the motor and the rod extending through the pressure chamber into the inlet chamber and including a first seal for selectively sealing the first port and a second seal for selectively sealing the second port. The first seal being in a closed condition when the rod is in the off position, the first and second seals being in an opened condition when the rod is in the drive position thereby allowing the associated air flow to reach the motor, and the second seal being in a closed condition and the first seal being in the open condition when the rod is in the torque blocked position thereby maintaining air flow into the pressure chamber.

The invention of this application relates to power drivers and has been found to work particularly well with push activated drivers and, more particularly, to a push to start pneumatic screwdriver or nut-runner with an automatic shut-off clutch that can utilize automatic monitoring systems to monitor the process of installing screws nuts or other types of fasteners. This application claims priority to provisional patent application Ser. No. 61/137,292 filed on Jul. 29, 2008 which is incorporated by reference herein.

### INCORPORATION BY REFERENCE

The invention of this application relates to push to start pneumatic screwdrivers or nut-runners with an automatic shut-off clutch which are known in the art. U.S. Pat. No. 4,071,092 to Wallace discloses a pneumatic screwdriver with torque responsive shut-off and is incorporated by reference for showing the same and forms part of the specification of this application. U.S. Pat. No. 5,167,309 to Albert et al discloses a torque control clutch and is incorporated by reference for showing the same and forms part of the specification of this application. Also attached are two pages from a tool catalog by SUMAKE showing a sectioned view of two styles of screwdriver, namely, a pistol grip style driver and an inline style driver. This catalog is incorporated by reference for showing the same and forms part of the specification of this application.

The invention of this application further relates to the use of the above drivers with automatic monitoring systems to monitor the process of installing screws, nuts or other types of fasteners. U.S. Pat. No. 6,871,153 to Lysaght discloses a dynamic calibration qualifier and is incorporated by reference for showing the same and forms part of the specification of this application. U.S. Pat. No. 6,567,754 to Lysaght also discloses a qualifier and is incorporated by reference for showing the same and forms part of the specification of this application. U.S. Pat. No. 6,055,484 to Lysaght discloses a tool monitor and assembly qualifier and is also incorporated by reference for showing the same and forms part of the specification of this application. U.S. Pat. No. 5,937,370 to Lysaght also discloses a tool monitor and assembly qualifier and is also incorporated by reference for showing the same and forms part of the specification of this application. All of these devices will hereinafter be generally referred to as qualifiers and/or monitors in the remaining portions of this application.

### BACKGROUND OF THE INVENTION

Powered screwdrivers and nut-runners have been known and used for many years in a wide range of fields to reduce the time and effort needed to secure virtually any kind of threaded fastener. Over the years, these drivers have improved in every way including the way in which these drivers can accurately and quickly drive a fastener. As can be appreciated, fast and accurate driving of fasteners is attractive to manufacturing environments wherein speed can improve productivity and accuracy can improve quality. Further, the ability to quantify the number of fasteners driven can help generate reports that can help both productivity analysis and quality control.

These improvements have been to both the tool itself and the equipment used in connection with the tool. In this respect, torque control systems have improved over the years to accurately control the amount of torque that is applied to a particular fastener. As can be appreciated, over tightening a fastener can damage both the fastener and the object the fastener is attached to which can ultimately result in quality problems. Similarly, under tightened fasteners can also cause quality problems by reducing the connective force between the fastener and the object. These improvements include the creation of the automatic shut-off clutch that can accurately stop the application of torque to the fastener when a predetermined level of torque has been applied.

U.S. Pat. No. 4,071,092 to Wallace discloses one particular configuration of a torque responsive shut-off that can be used to control the amount of torque applied to a fastener. Again, this patent is incorporated by reference herein and forms part of the specification of this application. U.S. Pat. No. 5,167,309 to Albert et al discloses another configuration of torque control and is incorporated by reference herein for showing the same and forms part of the specification of this application. Also attached are two pages from a tool catalog by SUMAKE showing a sectioned view of two styles of screwdriver, namely, a pistol grip style driver and an inline style driver. The SUMAKE drivers are known in the field and have been found to work particularly well for accurately driving a wide range of fasteners. It must be noted that while only a few drivers have been shown in this application, the invention of this application has broader application and can be used in connection with a wide range of pneumatic drivers known in the field and the drivers shown should only be interpreted as illustrative.

While these drivers, and others, have been found to work particularly well to improve quality and productivity, it was found that quality and productivity could be further improved by generating data relating to actual use of the tool. In this respect, if it could be determined, for example, the total number of fastening cycles and the details on each cycle, further improvements in quality and productivity could be achieved. This need resulted in the creation of qualifiers and/or monitors that can be used to monitor the operation of the tool through each cycle. This information can then be used for virtually any type of report including, but not limited to, quality analysis and productivity analysis and even employee performance analysis.

U.S. Pat. Nos. 6,871,153; 6,567,754; 6,055,484 and 5,937,370 to Lysaght disclose tool monitors that can be used for this process of monitoring the operation of one or more drivers. Again, these patents are incorporated by reference for showing the same and form part of the specification of this application.

While the combination of accurate torque systems and tool monitors has been found to be very effective, there are significant limitations in these existing drivers that prevent the use of these monitors for some of these drivers. In this respect, and as is discussed in greater detail in the Lysaghts patents, these monitors measure the air pressure in such a way that they can be used only with valve actuated drivers wherein the user pushes a trigger to activate the flow of air into the driver. These systems cannot be used in combination with existing push to start drivers since these drivers do not produce the necessary air pressure variations internally such as in a signal pressure chamber of the driver. This air pressure variation or pressure curve can be used to activate the monitor, show that the proper torque has been achieved, and/or that the cycle has been completed. As a result, even though push to start drivers are very popular, they cannot be fully utilized since many users desire the benefits of these monitoring systems.

### SUMMARY OF THE INVENTION

The invention of this application relates to push activated drivers and, more particularly, to a push to start pneumatic screwdriver or nut-runner with an automatic shut-off clutch that can utilize automatic monitoring systems to monitor the process of installing screws, nuts or other types of fasteners.

More particularly, the driver of this application includes a two stage valve which can be configured to produce an air pressure variation in a signal pressure chamber of the screwdriver that can be used to activate the monitor and show that the proper torque has been achieved and that the cycle is completed.

A driver according to one aspect of the invention of this application has both an inlet air chamber and a signal pressure chamber between the main air inlet of the tool and the driver's motor. Further, the driver includes a first seal between the two chambers and a second seal between the pressure chamber and the motor inlet. This configuration can allow the pressure chamber to continue to be pressurized even though the torque control has stopped the flow of the air to the motor, but also allows the pressure chamber to depressurize when the driver is removed from the fastener. The pressure chamber of the driver is then connected to a tool monitor to allow the monitor to measure the pressure variations in the pressure chamber. This arrangement allows push to start drivers to be used with monitoring systems.

A driver according to one aspect of the present invention includes an air inlet connectable to an air supply and a pneumatically driven motor drivable by air supply about a tool axis. The driver further including a bit holder, a torque control, and a push rod in mechanical communication with the torque control such that the rod is axially positionable between an off position, a drive position and a torque blocked position. The rod moving to the drive position in response to axial pressure being applied to the bit holder and driver further including an inlet air chamber and a signal pressure chamber fluidly connecting the air inlet and the motor. The driver further includes a port between the inlet and signal chambers and a second port between the pressure chamber and the motor and the rod extending through the pressure chamber into the inlet chamber and including a first seal for selectively sealing the first port and a second seal for selectively sealing the second port. The first seal being in a closed condition when the rod is in the off position, the first and second seals being in an opened condition when the rod is in the drive position thereby allowing the associated air flow to reach the motor, and the second seal being in a closed condition and the first seal being in the open condition when the rod is in the torque blocked position thereby maintaining air flow into the pressure chamber.

A driver according to another aspect of the present invention includes a housing extending between a first end and a second end. The driver further includes an air driven motor secured in the housing having a motor port for receiving an associated flow of pressurized air to drive the motor and drive an output drive member. The driver also includes a torque control, which can be a wide range of torque control devices and is driven by the output member and controls the torque applied to an associated fastener by the driver, the torque control having a torque pin moveable between an off position, a drive position and a torque blocked position. The driver also has a bit holder shaped to receive the associated tool bit and the holder being moveable between an extended position and a compressed position, the bit holder urging the torque pin to the drive position when in the compressed position. The driver further includes an inlet air chamber in the housing in fluid communication with the main inlet, the inlet chamber having a first exit port and a signal pressure chamber in fluid communication with the first exit port of the inlet chamber, the pressure chamber having a second exit port in fluid communication with the motor port, a monitor port connectable to an associated tool monitor to allow the associated monitor to measure the pressure variation in the pressure chamber, and a pressure relief opening wherein the relief opening can be smaller than the first exit port. The driver also includes a push rod engaging the torque pin such that the rod at least partially moves with the pin between the off position, the drive position and the torque blocking position. This rod can extend through the pressure chamber into the inlet chamber and includes an inlet seal for selectively sealing the first exit port and a motor seal for selectively sealing the second exit port, the inlet seal being in a closed condition when the rod is in the off position. The inlet seal and the motor seal are in an opened condition when the rod is in the drive position thereby allowing the associated air flow to reach the motor; and the motor seal being in a closed condition and the inlet seal being in the open condition when the rod is in the torque blocked position thereby maintaining air flow into the pressure chamber.

According to yet another aspect of the present invention, provided is a push to start driver for driving a fastener having a housing extending between a first end and a second end and a fluid flow inlet for receiving an associated fluid flow. The driver further including a motor secured relative to the housing having a motor port for receiving an associated fluid flow wherein the fluid flow drives the motor when the driver is in a drive condition. The driver further includes a signal pressure chamber in fluid communication between the inlet and the motor port and the pressure chamber including a fluid input and a fluid output wherein the output is fluidly connecting the inlet to the motor port. The driver also has a monitor port in fluid connection with the pressure chamber that is connectable to an associated tool monitor. The driver includes a first and a second seal and the first seal selectively sealing the fluid input and the second seal selectively sealing the fluid output of the chamber wherein the first and second seals are selectively sealable independently of one another in reaction to a specified operational event thereby producing a detectable pressure variation in the pressure chamber.

In addition, while the invention of this application was originally to overcome the shortcomings in push to start drivers, it has been found that the invention of this application also works in connection with other style drivers including, but not limited to, trigger activated drivers and, therefore, it should not be limited to push to activate drivers.

These and other objects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which form a part hereof and wherein:

FIG. 1 is a sectional view of a prior art in-line style push to start driver;

FIG. 2 is an enlarged side view of a rod assembly from the prior art driver shown in FIG. 1;

FIG. 3 is a sectional view of a driver according to certain aspects of the present invention;

FIG. 4 is an enlarged side view of a rod assembly as is shown in FIG. 3;

FIG. 5 is an enlarged sectional view of the air chamber region shown in FIG. 3 including the rod assembly shown in FIG. 4 wherein the air chambers and rod assembly are in a first condition;

FIG. 6 is the enlarged sectional view shown in FIG. 5 wherein the system is in a second condition;

FIG. 7 is the enlarged sectional view shown in FIG. 5 wherein the system is in a third condition;

FIG. 8 is the enlarged sectional view of the system shown in FIG. 5 wherein the system is in a fourth condition; and,

FIG. 9 is a pressure variation chart in relation to time;

FIG. 10 is the enlarged sectional view of the system shown in FIG. 5 wherein wireless technology is utilized;

FIG. 11 is the enlarged sectional view similar to the view shown in FIG. 5 showing other embodiments of the present invention wherein shown is the system in a modified third condition at the time when the proper torque has been reached;

FIG. 12 is the enlarged sectional view shown in FIG. 11 wherein the system is in a modified third condition and the proper torque has not been reached;

FIG. 13 is a pressure variation chart relating to the modified third condition of FIG. 11 showing proper installation of a fastener; and,

FIG. 14 is a pressure variation chart relating to the modified third condition of FIG. 12 showing improper installation of a fastener.

### DESCRIPTION OF PREFERRED EMBODIMENTS

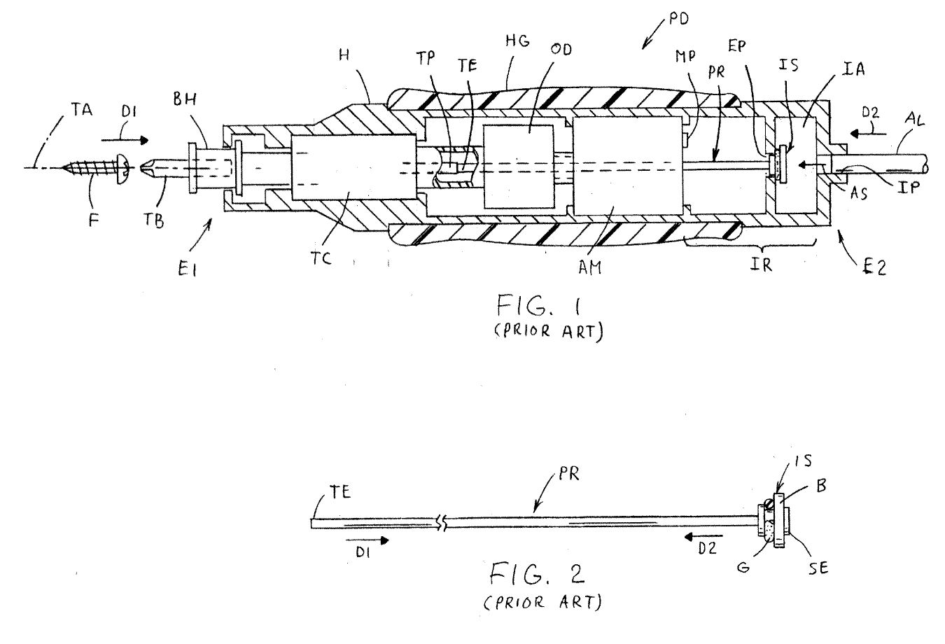

Referring now to the drawings wherein the showings are for the purpose of illustrating preferred and alternative embodiments of the invention only and not for the purpose of limiting the same, FIGS. 1 and 2 show a prior art driver PD that is an in-line style driver having a push to start configuration. In this respect, and as is known in the art, power drivers can come in a wide range of configurations. Frame wise, these include in-line style drivers wherein the entire driver extends about a single axis coaxial with the drive axis of the motor wherein the user's hand grips the driver about this single axis. Another type of driver is referred to as a pistol grip driver which includes a handle portion extending from the drive axis wherein the user's hand is spaced from the drive axis. While the pistol grip configuration is not shown in the drawings of this application, the invention of this application can apply to a wide range of drive housing configurations including, but not limited to, in-line drivers, pistol grip drivers and/or variations thereof.

Similarly, prior art drivers can have different types of drive actuation systems. FIG. 1 shows a push to start drive actuation system which is known in the art. This type of system does not include a trigger for activating the driver. Conversely, the driver is activated by pushing the bit holder axially to compress the bit holder into the driver. In operation, the user would position a tool bit on the bit holder. Then, once the tool bit is positioned against a fastener and pressure is applied to the fastener, pressurized air would be allowed to enter the drive motor which would propel the motor and drive the fastener. The invention of this application and the drawings shown in this application relate to these push to start style drivers. However, the invention of this application was surprisingly found to have broader application wherein it can be used to improve the monitoring of other style drivers including, but not limited to, trigger style drivers.

The driver PD shown in FIG. 1 includes a housing H having a housing grip HG which can be configured to ergonomically mate with the user's hand. Housing H extends between a first end E1 and a second end E2 wherein end E1 is the working end of the driver. Hand grip HG and housing H extend about a tool axis TA wherein the user's hand is coaxial with the tool axis for the shown in-line style driver. In this driver configuration, hand grip HG is between ends E1 and E2. Driver PD further includes an inlet port IP in housing H at end E2 which allows an air line AL to be connected to driver PD. Air line AL provides a pressurized air supply AS to be fed into the driver. Driver PD further includes an air driven motor AM which is fed by air supply AS to provide powered rotation about tool axis TA. This power is transmitted by an output drive OD which provides the necessary gear reduction to produce the torque needed for a particular application. As with all drivers, the output drive can provide a fixed gear ratio or can provide multiple gear ratios as is known in the art. Output drive OD transmits the power of motor AM into a torque control device TC which can be used to control the amount of torque applied to an associated fastener F driven by driver PD. As is also known in the art, a controlled amount of torque should be applied to the fastener such that the fastener is not damaged during assembly but is securely driven and secured to the desired object. In order to allow driver PD to work in connection with a wide range of fasteners, the driver can include a bit holder BH which allows different bits to be selectively used within the driver. As can be appreciated, the function of the bit holder is also to allow the replacement of worn bits which have a much shorter life expectancy than the driver itself.

Driver PD further includes an air inlet region IR near end E2 which provides the controllable fluid connection between air supply AS and motor AM. In this respect, driver PD includes an inlet air chamber IA in fluid connection with inlet port IP. Inlet chamber IA further includes an exit port EP separating chamber IA from a motor port MP for motor AM. Driver PD further includes an inlet seal IS that is joined to a push rod PR wherein push rod PR moves seal IS from an opened condition to a closed condition which will be discussed in greater detail below.

In operation, when a compressive force is applied to tool bit TB, it moves axially relative to the tool axis TA in a direction D1 and compresses bit holder BH into housing H. This action is translated to push rod PR by way of a torque pin TP in torque control TC. As torque pin TP and push rod PR are moved axially in direction D1, this movement is translated to seal IS of inlet region IR such that seal IS opens thereby allowing the compressed air AS to enter motor AM by way of motor port MP. The application of air to the motor drives bit holder BH about axis TA thereby turning fastener F.

Then, once a desired torque has been reached, torque control TC senses this condition and the clutch mechanism of the torque control activates wherein torque pin TP automatically moves axially in direction D2. This axial movement is translated to push rod PR wherein push rod PR also moves in direction D2 thereby moving seal IS into a closed or sealed condition and this action is done automatically. Accordingly, the air to the motor is shut off while the bit holder is still in the compressed condition. At this time, the user would remove driver PD from the fastener thereby allowing the bit holder to extend axially from the compressed position in direction D2 to the extended position. This extending motion in direction D2 then resets the driver for driving the next fastener. This configuration allows driver PD to shut off at a desired torque level by shutting off the flow of air to the driver as opposed to other systems which provide controlled slippage between two members of a clutch. As can be appreciated, the controlled slipping clutch arrangement can create a significant amount of heat and a high wear condition. These conditions can reduce the life expectancy of the driver and can create variations in the torque setting during extended use.

While this push to start clutch mechanism has been found to be effective in the field, it is not capable of being used in connection with a tool monitor system which will be discussed in greater detail below.

With particular reference to FIG. 2, shown is push rod PR of driver PD. Push rod PR extends from a torque end TE to a seal end SE and is generally formed by a steel rod having a circular cross-sectional configuration. In operation, the torque pin TP engages torque end TE of push rod PR as the tool and bit holder are compressed by the operator during engagement with fastener F. This motion in the compression direction corresponding to direction D1 of FIG. 1 is translated to seal IS since this component is attached to the push rod. Seal IS, as with any seal in this application, can be any known sealing arrangement configured to selectively seal an air port. In this instance, seal IS is configured to selectively seal exit port EP of driver PD. Further, seal IS includes a rigid backer section B and a gasket section G wherein gasket G is forced against exit port EP when rod PR moves in an extending direction corresponding to direction D2 of FIG. 1. Accordingly, movement between direction D1 and direction D2 effectively opens and closes exit port EP thereby controlling the air supply to motor AM. When the seal is in the open position, the motor is provided with compressed air and will provide rotational movement. When the seal is in the closed position, the motor will not turn.

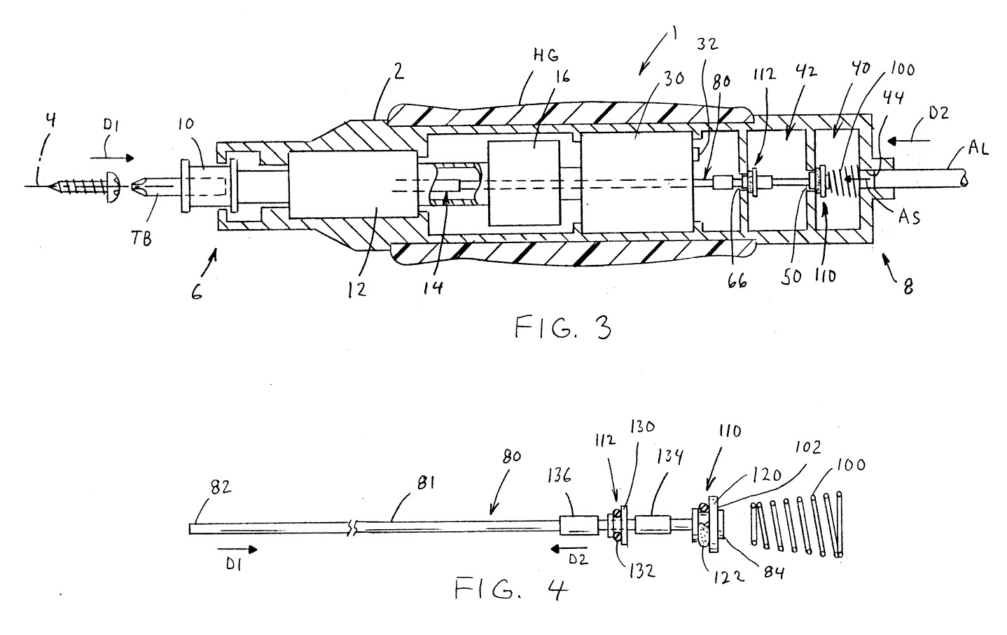

With reference to FIGS. 3-9, shown is an illustration of a push to start power driver 1 having a housing 2, that is, in this embodiment, an in-line style driver which extends about a tool axis 4 between a first end 6 and a second end 8. In this configuration, end 6 is the working end of the driver. Driver 1 can further include a bit holder 10 extending from first end 6 shaped to receive a wide variety of tool bits TB. Further, driver 1 can include a torque control device 12 having a torque pin 14 wherein control 12 can be configured to move pin 14 in direction D2 when a desired torque is reached as will be discussed in greater detail below. Further, while it has been found that the invention of this application overcomes limitations relating to a push to start driver, it has been found that the invention of this application has broader applications wherein the invention can be used on other style drivers to improve monitoring such as used on trigger style drivers.

Since the majority of driver 1 can use the same technology as prior art driver PD described above, all components of the driver will not be discussed again in detail in this section in the interest of brevity. However, it is to be understood that driver 1 can include any feature and/or configuration described above and in other drivers known in the art without detracting from the invention of this application.

Driver 1 further includes an air driven motor 30 having an inlet motor port 32 such that a compressed air supply AS can be directed through motor port 32 and rotate motor 30 about axis 4. As is discussed in greater detail above, motor 30 drives an output drive 16 which further drives torque control unit 12 and bit holder 10 of driver 1. Driver 1 further includes an inlet chamber 40 and a pressure chamber 42. Inlet chamber 40 can include the main inlet port 44 for feeding air supply AS to driver 1. Inlet chamber 40 further includes a first exit port 50 which fluidly connects chamber 40 with chamber 42 such that the flow of compressed air AS can travel from chamber 40 to chamber 42. While the drawings of this application show the chambers being formed by housing 2 of driver 1, this is not required and chambers 40 and/or 42 could be separate components from housing 2 without detracting from the invention of this application.

Pressure chamber 42 is fluidly positioned between chamber 40 and motor port 32 and includes a monitor port 60 and can include an air relief port 62. While not shown, exit port 62 could be formed from or in port 60 and/or in connection with the monitor. In one embodiment, monitor port 60 is an external port which is not required in that it could be internal. Pressure chamber 42 further includes a second exit port 66 which is in fluid connection with motor port 32. Monitor port 60 allows pressure chamber 42 to be in fluid communication with an associated pressure monitor 70 which will also be discussed in greater detail below. Pressure chamber 42 can be connected to monitor 70 by way of air fitting 72 and an air line 74.

Power driver 1 further includes a push rod 80 having a rod portion 81 extending between a first end 82 and a second end 84. Push rod 80 can be a metal rod having a circular cross-sectional configuration extending between ends 80 and 84. However, this configuration is not required. In this embodiment, rod 80 is coaxial with axis 4 and extends through motor 30 and chamber 42 and into chamber 40. End 82 of rod 80 is in mechanical engagement with an end 90 of torque pin 14. This mechanical relationship is such that movement of torque pin 14 in direction D1 urges rod 80 in direction D1 which will also be discussed in greater detail below. Driver 1 can further include a biasing member 100 used to force pin 90 and/or rod 80 back towards extension direction D2. Biasing member 100 can be any biasing member known in the art including, but not limited to, a compression spring and member 100 can engage an end surface 102 of push rod 80.

Push rod 80 further includes an inlet sealing member 110 and a motor sealing member 112. With respect to inlet sealing member 110, this member can be positioned within inlet chamber 40 and is positioned at or near end 84 of the rod. Sealing member 110 includes a rigid portion 120 and a sealing portion 122 wherein sealing member 110 is configured to selectively close first exit port 50 thereby preventing the pressurized air from entering into pressure chamber 42. Again, the function of this arrangement will be discussed in greater detail below. The sealing members can be joined to push rod 80 by any means known in the art including, but not limited to, friction welding, braising and the use of adhesives. Further, sealing members 110 and/or 112 can be fixed relative to rod portion 81. Further, in yet other embodiments, sealing members 110 and/or 112 can be integral with rod portion or a separate component such as seal 110 including its own rod portion that is joined to seal 112 and rod 80.

In one embodiment, motor seal 112 also includes a rigid portion 130 and a sealing portion 132 and is also joined to main rod 81. However, motor seal 112 is allowed to move axially relative to main rod 81 to help facilitate a proper seal. In this embodiment, motor seal 112 includes a locking collar 134 and a locking collar 136 on either side to control the relative motion of motor seal 112 relative to rod member 81. This can be used to help facilitate a good seal between the motor seal and second exit port 66 and allows for the selective sealing of seal 112 separately from seal 110. As a result of this configuration, inlet seal and motor seal are only generally fixed relative to one another on main rod 81 of push rod 80, but the movement of torque pin 14 and push rod 80 can be translated to both seals 110 and 112 which will be discussed in greater detail below.

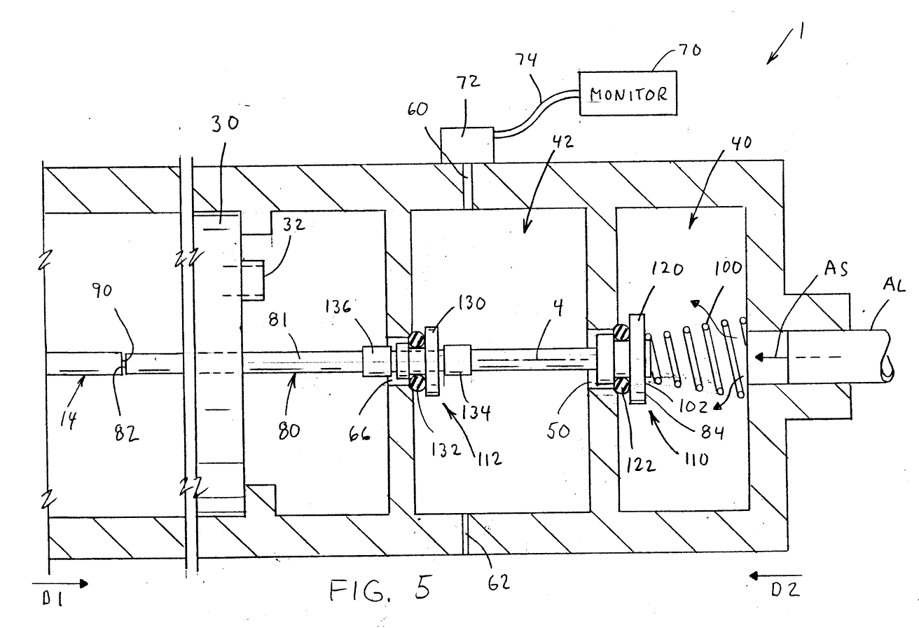

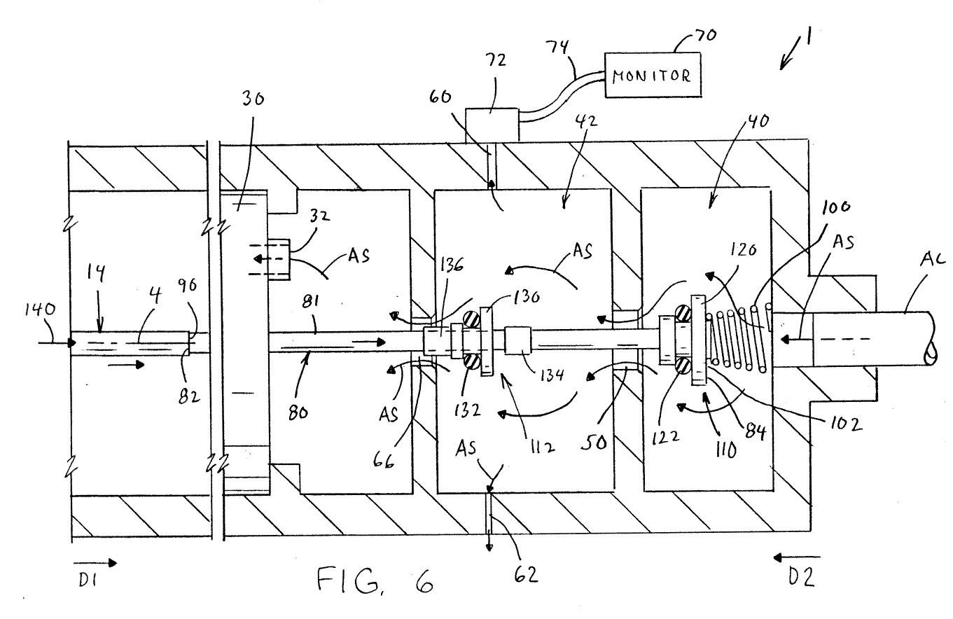

When driver 1 is at rest, it is in a condition I as is shown in FIG. 5. In this condition, the air supply is blocked from pressure chamber 42 by inlet seal 110 since push rod 80 is in its full extended position in direction D2. This is the condition of driver 1 prior to fastener installation. No force is being applied to tool bit holder 10 and/or push rod 80 and both seals 110 and 112 are both in a closed condition. Accordingly, no pressurized air reaches motor 30 and driver 1 is essentially off.

As an application force 140 is applied to driver 1, the driver moves from the condition I shown in FIG. 5 to a condition II shown in FIG. 6. More particularly, as the user positions tool bit TB on an associated fastener F and applies a compressive force toward the fastener, the bit holder compresses and moves in axial direction D1. This compression of the bit holder is translated through driver 1 wherein torque pin 14 and push rod 80 move together in axial direction D1. This movement opens both inlet seal 110 and motor seal 112 thereby allowing compressed air AS to enter into pressure chamber 42 and pass through this pressure chamber into motor port 32. This condition thereby allows the compressed air to reach drive motor 30 and rotate drive motor 30 about axis 4 which in turn produces the driving force to drive fastener F. In this condition, the compressed air AS freely passes through chamber 42 and motor 30; however, chamber 42 does have an elevated pressure.

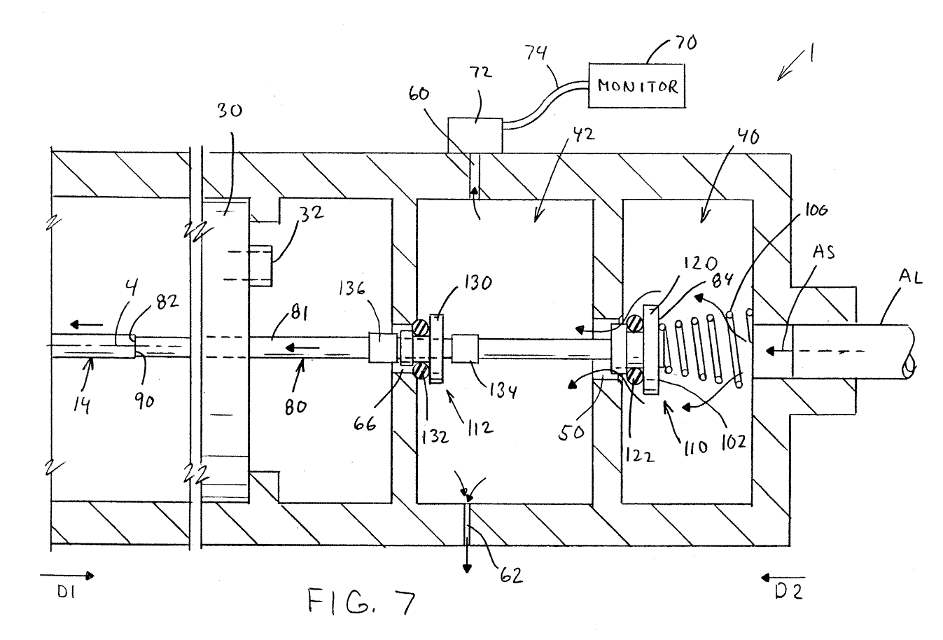

Once torque control 12 reaches a desired torque setting, the system move to condition III as is shown in FIG. 7. More particularly, once this torque setting is reached, torque pin 14 is allowed to move axially in direction D2 even though the user is still applying the necessary application force to fastener F. Essentially, the bit holder is maintained in its full compressed condition and movement of torque pin 14 is based on the action within torque control 12. This torque pin actuation is known in the art and will not be discussed in greater detail herein in the interest of brevity. While torque pin moves axially in axial direction D2, it only moves partially in this direction wherein driver 1 does not revert back to the condition I shown in FIG. 5. Conversely, this partial motion in direction D2 allows only motor seal 112 to reach a sealing position while preventing inlet seal 110 from reaching a sealing position or at least at the same time. As can be appreciated, much of the actions of the driver described in this application take place in a very short period of time wherein these conditions may exist for only a very short period of time. Again, as was discussed above, motor seal 112 can be configured to have some axial movement relative to main rod 81 to facilitate this sealing of second exit ports 66 while first exit port 50 is maintained in an opened position. As a result, in condition III, pressure chamber 42 still receives a flow of compressed air from inlet chamber 40; however, this flow is not able to reach the motor. Therefore, while chamber 42 is maintained in a pressurized condition, motor 30 stops in view of the lack of air flow to motor 30. However, pressure increases in pressure chamber 42 since the air supply is not allowed to flow outwardly into the motor.

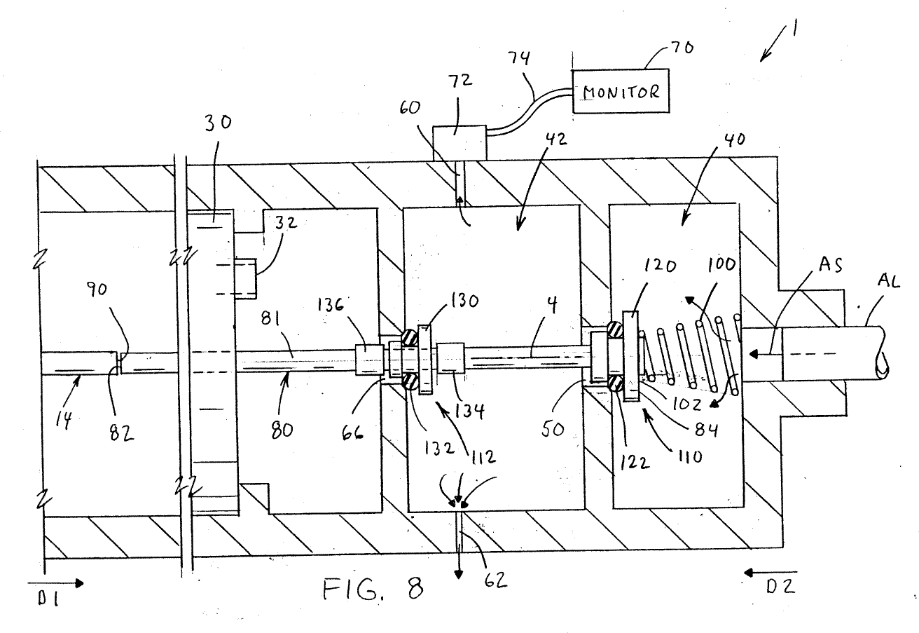

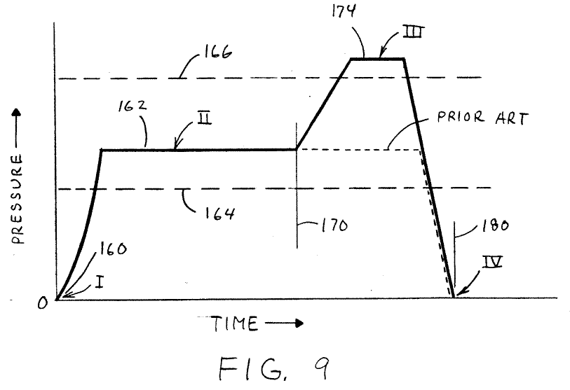

Subsequently, when the user removes driver 1 from fastener F, the torque system 12 resets such that torque pin 14 is free to move back into its home position. This allows spring 100 to urge push rod 80 in direction D2 and, thus, torque pin 14 further in axial direction D2 thereby moving the system from condition III shown in FIG. 7 to a condition IV shown in FIG. 8. In this condition, as with condition I, inlet seal 110 is now in a sealed position wherein the flow of air from inlet chamber 40 to pressure chamber 42 is blocked. Different from condition I is that pressure remains is chamber 42 for at least a period of time. However, this pressure can be evacuated from chamber 42 by pressure relief opening 62. The rate of pressure drop due to air exiting opening 62 can be controlled and with respect to other actions of the driver is relatively slow. Further, the evacuation of pressure from chamber 42 can be used to indicate the end of a cycle for monitor 70. As can be appreciated, port 62 produces a continuous air flow or leak when pressure chamber 42 is pressurized. Accordingly, opening 62 is configured to be small enough to minimize the amount of air lost through this opening during the driving of the fastener, but which allows the unwanted pressure in chamber 42 to be evacuated quickly enough to depressurize this chamber in between the driving cycles of the driver. Again, this can be used to reset monitor 70 to count the conclusion of the cycle and thus the number of cycles in which driver 1 is used by an operator or user.

With special reference to FIG. 9, shown is a pressure variation chart which corresponds to the conditions (I-IV) discussed above. As was referenced above, the amount of time for these cycles can be very small wherein these cycles can be illustrative of a virtually instantaneous event during the overall cycle of installing a fastener. This pressure chart relates to the pressure found in pressure chamber 42 as it is monitored or sensed by monitor 70. In the interest of brevity, a detailed discussion of monitor 70 is not being given since this technology is known in the art.

More particularly, when driver 1 is in the condition I, pressure chamber 42 is completely evacuated wherein pressure 160 is essentially zero or at atmospheric pressure. Then, once the operator or user compresses the bit holder on a fastener, the pressure chamber is pressurized wherein this chamber moves from the “zero” pressure to an operating pressure 162. As pressure increases from “zero” to operating pressure 162, a lower pressure threshold 164 is passed which activates monitor 70 wherein monitor 70 senses that a cycle has begun. Driver 1 remains in this condition for a time 170 until fastener F reaches a desired torque level. At time 170, when the desired torque is reached, driver 1 moves into condition III wherein inlet or first seal 110 remains in an opened position, but motor or second seal 112 is closed. In this condition, pressure in pressure chamber 42 climbs until it reaches a maximum pressure 174 thereby passing a high threshold pressure 166 which allows signal monitor 70 to sense that the fastener has reached the desired torque. The time in which it takes to achieve this desired torque can be used to determine whether or not the fastener has been properly driven. In other embodiments, different factors are used to determine if the fastener has been fastened to the proper torque setting some of which will be discussed in greater detail below.

Once the driver stops rotation, the operator or user knows that the fastener has been driven. At that time, the pressure being applied to fastener F is removed wherein the torque pin and rod 80 are reset such that inlet seal 110 moves to a closed position such that both seals 110 and 112 are in a closed position. Once in this position, the flow of pressurized air to pressure chamber 42 is turned off and the pressure within this chamber moves from pressure high 174 back to “zero” signifying the end of cycle 180. Again, pressure can be relieved from this chamber by way of pressure relief opening 62. The information on pressure and time can then be used to analyze or monitor the operation of driver 1 wherein this information, as was discussed above, can be used to monitor production levels and/or the quality of the fastening operation.

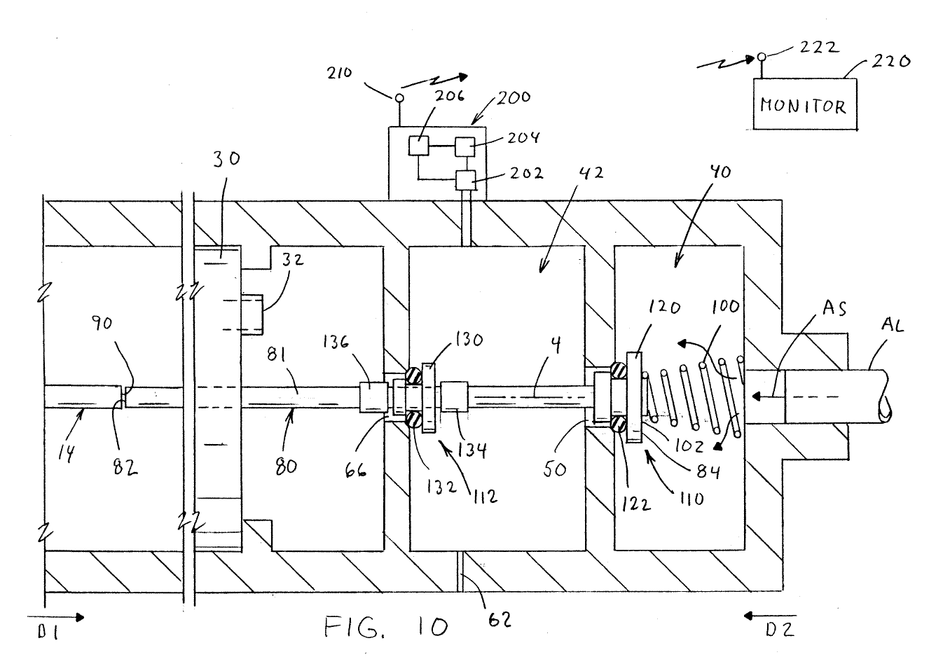

With reference to FIG. 10, yet another embodiment can utilize wireless technology to monitor the assembly cycle of the driver. In this respect, port 60, or an internal port (not shown) in chamber 42 can be joined to a compact sensing unit 200 which can detect the pressure variations in chamber 42. More particular, unit 200 can include a micro-sized sensing unit 202 that can sense the pressure in chamber 42 by way of port 60. This information can be communicated to a processor 204, stored locally in a memory store 206 and/or sent via sending device and/or transceiver 210 to a monitor 220 which can also include a receiver and/or a transceiver 222. This configuration allows for more freedom of movement of driver 1. The driver of this application can also be used with other monitoring devices known in the art or which will be known in the art in the future without detracting from the invention of this application.

In yet other embodiments of the invention of this application, and with reference to FIGS. 5, 6, 8, 11-14, the sequence of the valves is modified. In this respect, driver 1 can include different sealing configurations to allow seal 110 to be selectively sealable separately from seal 112 to produce different pressure curves or variations in chamber 42. These pressure curves can be used to monitor different aspects of the fastening operation as is desired. The driver can be configured to selectively seal one or both of the pressure chamber seals in reaction to a specified operational event. It has been found that the sealing arrangement of the following embodiment works particularly well to determine whether or not the proper torque setting has been reached or if the operator released the driver before the desired torque setting had been reached. As can be appreciated, when job performance is based on production numbers, there can be a tendency to remove the driver from the fastener before the desired torque has been reached to increase production numbers. This particular embodiment has been found to monitor this situation well.

More particularly, in this embodiment, when driver 1 is at rest, it is in a condition I which is shown in FIG. 5 and which was described above. In this condition, both seals 110 and 112 are able to be in a closed condition. As will be discussed in greater detail below, being able to be in the closed position does not mean it is completely closed. However, at least one seal is closed wherein no pressurized air reaches motor 30 and driver 1 is essentially off. In addition, the pressure in chamber 42 is not elevated above the “zero” level or atmospheric pressure.

As application force 140 moves the driver from the condition I shown in FIG. 5 to a condition II shown in FIG. 6, both seals 110 and 112 are moved to an opened condition. However, in view of the collar arrangement of seal 112, this seal does not move as far in direction D1 as does seal 110 since seal 112 will not be forced in direction D1 until it is engaged by collar 136. The amount of gap between collars 134 and 136 and the position of these collars can be used to determine the amount of movement of seal 112. In this condition, the air supply is directed to the motor and the driver will turn the fastener in that air is being supplied to the motor. As the air supply reaches chamber 42, the pressure in this chamber increases until it reaches a balanced point where it remains relatively constant during the turning of the fastener.

This relatively constant chamber pressure in chamber 42 continues until one of two events takes place. The first of these two events is when the desired torque is reached. The second is when the user removes the driver before the desired torque is achieved.

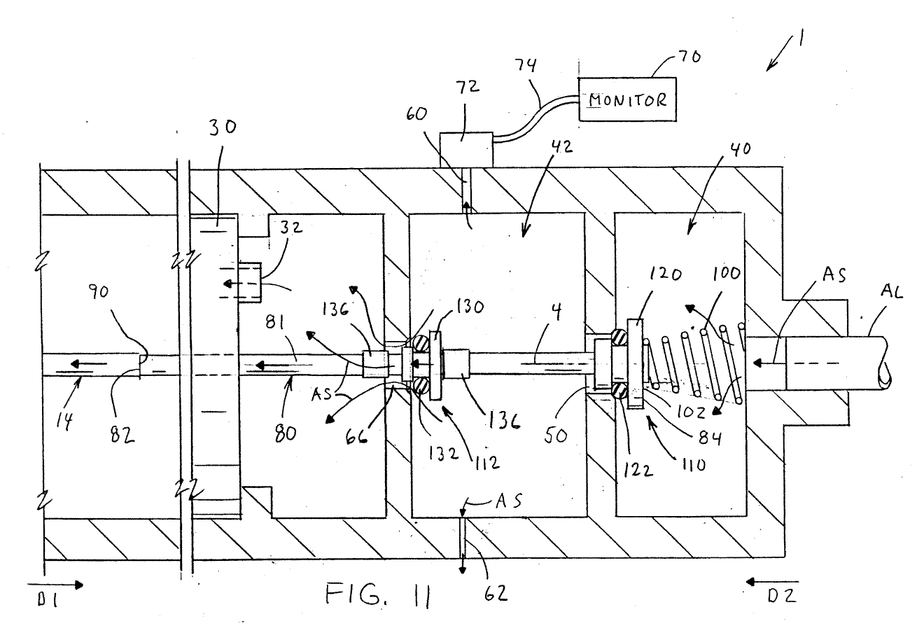

With respect to the first event, once torque control 12 reaches this desired torque, the system moves to condition IIIA shown in FIG. 11. More particularly, once this torque setting is reached, torque pin 14 is allowed to move axially in direction D2 even though the user is still applying the necessary application force to fastener F. While torque pin 14 moves axially in axial direction D2, it moves only partially in this direction wherein driver 1 does not revert back to the condition I shown in FIG. 5. This partial movement does not allow collar 136 to force seal 112 into a sealing engagement. Conversely, this partial motion in direction D2 only forces inlet seal 110 into a sealing engagement. While the collar arrangement of seal 112 allows seal 112 to seal, the speed of this action forces inlet seal 110 into a sealing position quicker than the air pressure forces seal 112 into a sealing engagement. Thus, for a short amount of time, only seal 110 is sealed and since seal 112 is at least partially open during this short time period, the air in chamber 42 is evacuated more quickly than if evacuated through port 62. As a result, in condition IIIA, pressure chamber 42 no longer receives a flow of the compressed air from inlet chamber 40; however, the remaining air in the pressure chamber is quickly evacuated in that seal 112 remains open. This creates a sudden drop in pressure in chamber 42 which can be sensed by monitor 70.

Subsequently, when the user removes driver 1 from fastener F, the torque system 12 resets such that torque pin 14 is free to move back into its home position. This allows, spring 100 to urge push rod 80 in direction D2 and, thus, torque pin 14 further in axial direction D2 thereby moving the system from the condition IIIA shown in FIG. 11 to condition I shown in FIG. 5 with “zero” chamber pressure. In this condition, as with the condition I, motor seal 112 is allowed to seal, but may not, and inlet seal 110 is closed.

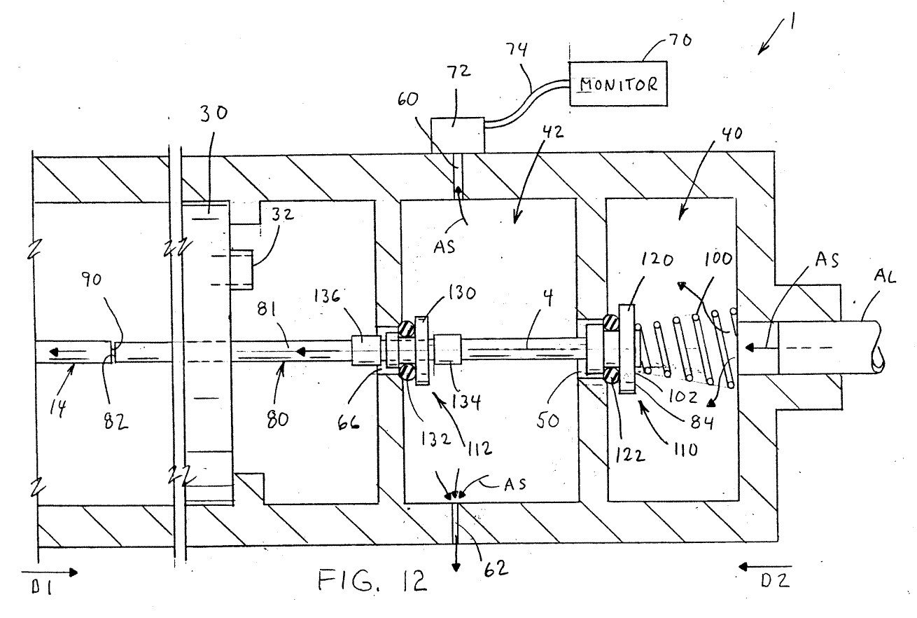

With respect to the second event, if the driver does not reach the desired torque setting for any reason (such as the user pulling the driver from the fastener prematurely), the driver will go directly to condition IIIB shown in FIG. 12 which is similar to condition IV shown in FIG. 8 discussed above. In this event, since the removal of the tool by the user is relatively much slower, the sealing of seal 110 will be after seal 112. More particularly, when the driver is driving the fastener (FIG. 6), seal 110 is spaced further from port 50 than seal 112 is spaced from port 66. Further, the movement of seal 110 toward port 50 is controlled by the movement of rod 80 in direction D2. The closer seal 112 is not fully restricted by the movement of rod 80 and the air pressure in chamber 42 will force the closer seal 112 into a closed position first. Since seal 112 closes first, chamber 42 will experience a pressure increase for a short amount of time. Then, the pressure decrease in chamber 42 will be slower in this condition since it will be forced to exit only through port 62. Thus, this pressure spike and subsequent slower pressure drop can be utilized to detect or sense an under torqued fastener.

It has been found that the closing sequence of this embodiment can produce more reliable data for error-proofing. These differences in pressure drop in chamber 42 between a torque achieved and a torque not achieved is significant enough to be detected by monitor 70. This allows the system to better distinguish a properly torqued fastener from an under torqued fastener.

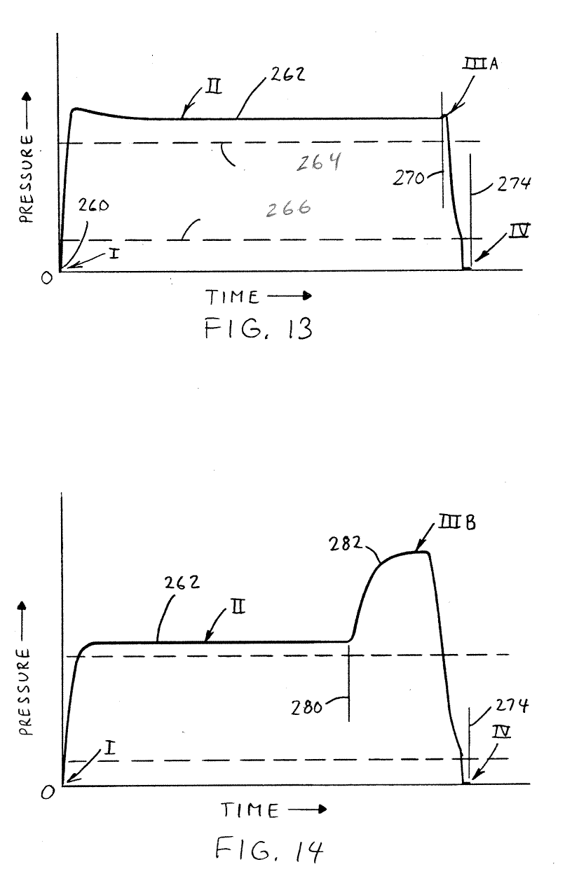

With special reference to FIGS. 13 and 14, shown are the pressure variations for this embodiment. More particularly, when driver 1 is in the condition I, pressure chamber 42 is completely evacuated wherein pressure 260 is essentially “zero” or at atmospheric pressure. Then, once the operator or user compresses the bit holder on a fastener, the pressure chamber is pressurized wherein this chamber moves from the “zero” pressure to an operating pressure 262. As pressure increases from “zero” to operating pressure 262, a first or high pressure threshold 264 is passed which activates monitor 70 and signifies the start of the cycle. The driver remains at the operating pressure while the fastener is being driven for a time 270 until fastener F reaches a desired torque level. At time 270, when the desired torque is reached (see FIG. 13), driver 1 moves into condition IIIA wherein inlet or first seal 110 is closed first and motor or second seal 112 remains opened for at least a short amount of time after the sealing of seal 110. In this condition, pressure in pressure chamber 42 will immediately drop until it reaches “zero” or atmospheric pressure 274. When it passes second or lower threshold 166 it signals the end of the cycle. When the cycle is completed, monitor 70 evaluates the pressure curve to see if the proper torque was achieved and also how long the time was between when the pressure rose above threshold 264 until it dropped below threshold 266. The monitor then compares this time against preset minimum and maximum times to make sure that cross threading or strip out did not occur. Once the driver stops rotation, the operator or user knows that the fastener has been driven. At that time, the pressure being applied to fastener F is removed wherein both seals are closed.

However, if driver 1 is removed before the desired torque is achieved at time 280 (see FIG. 14); this will cause seal 112 to close before seal 110 causing an increase in pressure in chamber 42. This condition will cause a short but detectable increase in pressure 282 with condition IIIB. This increase in pressure can be detected and can signify that the proper torque was not achieved. Further, in order to help confirm this condition, the rate of evacuation can be monitored. This event can be recorded and/or associated with an alarm to warn the operator of the potential existence of an under torqued fastener. Then, the pressure in chamber 42 is evacuated by way of port 62, as is discussed in greater detail above, until driver reaches condition I.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. These include various fluid flows to drive the motor. Accordingly, it is to be distinctly understood that the foregoing descriptive matter is to be interpreted merely as illustrative of the invention and not as a limitation.

It is claimed:

1. A pneumatic driver for driving a fastener, said driver comprising:
a housing extending between a first end and a second end;
an air driven motor secured in said housing having a motor port for receiving an associated flow of pressurized air to drive said motor;
a torque control having a torque pin moveable between an off position, a drive position and a torque blocked position;
a bit holder shaped to receive an associated tool bit, said holder being moveable between an extended position and a compressed position, said bit holder urging said torque pin to said drive position when moved to said compressed position;
a main air inlet in said housing being connectable to an associated air supply;
an inlet air chamber in said housing in fluid communication with said main inlet, said inlet chamber having a first exit port;
a signal pressure chamber in fluid communication with said first exit port, said pressure chamber having a second exit port in fluid communication with said motor and a monitor port connectable to an associated tool monitor to allow the associated monitor to measure a chamber pressure in said pressure chamber;
a push rod assembly in mechanical engagement with said torque pin such that said rod at least partially moves with said torque pin between said off position, said drive position and said torque blocking position, said rod extending through said pressure chamber into said inlet chamber and including an inlet seal for selectively sealing said first exit port and a motor seal for selectively sealing said second exit port, said inlet seal being in a closed condition when said rod is in said off position, said inlet seal and said motor seal being in an opened condition when said rod is in said drive position, one of said motor seal and said inlet seal closing before the other of said one seals as said rod moves into said torque blocked position.

2. The driver of claim 1, wherein said driver is an inline driver.

3. The driver of claim 1, wherein said mechanical engagement of said push rod is in direct contact with said torque pin.

4. The driver of claim 1, wherein said pressure chamber further includes a pressure relief opening.

5. The driver of claim 1, wherein said at least one of said motor seal and said inlet seal closing first is said motor seal, said inlet seal remaining opened when in said torque blocked position.

6. The driver of claim 1, wherein said at least one of said motor seal and said inlet seal closing first is said motor seal and said other seal being said inlet seal.

7. The driver of claim 6, wherein said motor seal moves axially relative to said inlet seal.

8. The driver of claim 1, wherein said at least one of said motor seal and said inlet seal closing first is said inlet seal and said other seal being said motor seal, said motor seal being closable based on air pressure alone when in said torque blocked position.

9. The driver of claim 8, wherein said motor seal moves axially relative to said inlet seal.

10. The driver of claim 1, further including a spring providing a spring force urging said rod assembly toward said first end, said spring force forcing only said inlet seal into said closed condition when said driver moves to said torque blocked position.

11. A driver for driving a fastener, said driver comprising a housing extending between a first end and a second end in an axial direction and having a fluid flow inlet for receiving an associated fluid flow, said driver further including a fluidly driven motor secured relative to said housing having a motor port for receiving the associated fluid flow wherein said fluid flow drives said motor when said driver is in a drive condition turning a bit holder on said first end, said driver further including a signal pressure chamber in fluid communication between said inlet and said motor port, said pressure chamber including a fluid input and a fluid output and said fluid output being in fluid communication with said motor port, said driver further including a monitor port in fluid connection with said pressure chamber that is connectable to an associated tool monitor such that a chamber pressure of said pressure chamber is communicated to the associated monitor, said driver further including a push member having a first seal configured to close said inlet and a second seal configured to close said outlet, said member being movable between a first condition wherein at least said first seal is closed, a second condition wherein said first and second seals are open and a third condition wherein said first seal is closed and said second seal is closeable, said push member moving into said third in response to a specified operational event.

12. The driver of claim 11, wherein said specified operational event is a torque blocked event.

13. The driver of claim 11, wherein said driver is a push to start driver.

14. The driver of claim 11, wherein in said third condition, said first seal closes before said second seal.

15. The driver of claim 14, wherein said second seal can move axially relative to said first seal.

16. The driver of claim 11, wherein said second condition, said first seal is axially spaced from said inlet a first distance and a second seal is axially spaced from said outlet a second distance, said first distance being greater than said second distance.

17. The driver of claim 16, wherein said driver further includes a spring urging said push member in said axial direction toward second first end, said spring urging only said first seal closed when in said third condition.

18. The driver of claim 11, wherein in said driver further includes a spring urging said push member in said axial direction toward second first end, said spring urging only said first seal closed when in said third condition.

19. A pneumatic driver for driving a fastener, said driver comprising an air inlet connectable to an associated air supply and a pneumatically driven motor driveable by the associated air supply about a tool axis, said driver further including a torque control and a push rod assembly in mechanical communication with said torque control such that said push rod is axially positionable between an off condition, a drive condition and a torque blocked condition, said driver further including an inlet air chamber and a signal pressure chamber fluidly connecting said air inlet and said motor, said driver having a first port between said inlet and signal chambers and a second port between said pressure chamber and said motor, said rod assembly including a first seal for selectively closing said first port and a second seal for selectively closing said second port, said first seal being fixed relative to said rod while said second seal having limited axial movement relative to said rod, said first seal being in said closed position when said rod is in said off position, said first seal being in an opened condition and spaced from said inlet a first distance and second seal being in an opened condition and spaced from said inlet a second distance when said rod is in said drive condition thereby allowing the associated air flow to reach said motor, said first distance being unequal to said second distance such that one of said first and second seals closes before the other of said first and second seals when said rod assembly moves from said drive condition to said torque blocked condition.

20. The driver of claim 19, wherein said first distance is greater than said second distance.

21. The driver of claim 20, further including a biasing member urging said rod assembly into said torque blocked condition, said spring forcing only said first seal into closed condition.

22. The driver of claim 21, wherein said one of said first and second seals closing is said first seal.

23. The driver of claim 22, wherein said second seal closes first when said driver moves from said drive position to said off position.

24. The driver of claim 19, wherein said one of said first and second seals closing is said first seal, said second seal closing first when said driver moves from said drive position to said off position.

25. The driver of claim 19, wherein said one of said first and second seals closing is said second seal.

26. A push to start driver for driving a fastener, said driver comprising a housing extending between a first end and a second end and having a fluid flow inlet for receiving an associated fluid flow, said driver further including a fluidly driven motor secured relative to said housing having a motor port for receiving the associated fluid flow wherein said fluid flow drives said motor when said driver is in a drive condition, said driver further including a signal pressure chamber in fluid communication between said inlet and said motor port, said pressure chamber including a fluid input and a fluid output and said output fluidly connecting said fluid flow inlet to said motor port, said driver further including a monitor port in fluid connection with said pressure chamber that is connectable to an associated tool monitor, said driver having a first and a second seal, said first seal selectively sealing said fluid input and said second seal selectively sealing said fluid output of said pressure chamber, said first and second seals being selectively sealable independently of one another in reaction to a specified operational event thereby producing a detectable pressure variation in said pressure chamber.

27. The driver of claim 26, wherein said operational event is the associated fastener reaching a desired proper torque.

28. The driver of claim 26, wherein said operational event is said driver being removed from the associated fastener before reaching a desired torque.
